(19) United States
(12) Patent Application Publication
(10) Pub. No.: US 2008/0084048 A1
(43) Pub. Date: Apr. 10, 2008

(54) TELESCOPIC STEERING ARM ASSEMBLY

(76) Inventors: Daniel Vergara, Madrid (ES); Werner Zahn, Hassloch (DE)

Correspondence Address: DEERE & COMPANY, ONE JOHN DEERE PLACE, MOLINE, IL, 61265, US

(21) Appl. No.: 11/680,678

(22) Filed: Mar. 1, 2007

(30) Foreign Application Priority Data
Mar. 2, 2006 (DE) 10 2006 009 673.8

(51) Int. Cl. B60D 1/42; B60D 1/36

(52) U.S. Cl. 280/477

(57) ABSTRACT

The invention relates to a telescopic steering arm assembly for a vehicle-implement coupling mechanism. There is a need for a steering arm assembly housing which is simple and inexpensive to manufacture. A steering arm assembly includes a steering arm, a housing, a detent mechanism and a cover. The housing has a detent channel and forms a rim surrounding an opening of the detent channel. An attaching groove is formed in the rim. The detent mechanism is movable in the detent channel to releasably holding the steering arm in the housing. The cover is mountable on the rim to cover the detent mechanism. The cover has a mounting bead which engages the attaching groove of the rim.

### FIELD OF THE INVENTION

The present invention relates to a telescopic steering arm assembly for attaching to an agricultural implement.

### BACKGROUND OF THE INVENTION

It is known to use telescopic steering arms in coupling mechanisms, such three-point coupling mechanisms or hitches, to couple a towed agricultural implements to a tractor. With such steering arms the operator of the tractor need not steer precisely at the connecting points of the attached implement and can extend or telescope the steering arm by releasing it from the detent mechanism and connect it with the implement. Subsequently, the operator need only move the tractor towards the implement so that the steering arms are retracted into the housing and are again immobilized by the detent mechanism.

Such steering arms have a housing which has a cavity with an elongated rectangular cross section which slidably receives an extendable arm. The housing is formed by two generally symmetrical forged halves which are welded to each other to form a housing with a pair of wider sides and a pair of narrower sides. The wider sides are parallel to the long dimension of the rectangular cross section. The housing includes a cavity closure wall in a connecting region which connects the housing to a rigid guide steering arm of the attachment mechanism. In such known steering arms, the weld seam which connects the two halves to each other extends along the wider sides, and along the closure wall. Because of the elongated shape of the housing cross section, the two forging require a highly accurate set up during the forging process. This results in an expensive forging process, high maintenance costs for the forging tools and correspondingly necessary rework by milling, in order to attain reasonable tolerances. Moreover, the detent mechanisms provided on the housing require costly additional manufacturing steps for their installation. In addition, the detent mechanisms are connected to the housing by additional fastening devices, for example, screw connections, that result in a large number of parts.

### SUMMARY OF THE INVENTION

Accordingly, an object of this invention is to provide a housing for a telescopic steering arm which is simple and inexpensive, and which has fewer parts.

This and other objects are achieved by the present invention, wherein a housing for a telescopic steering arm which overcomes the aforementioned problems.

According to the invention, a telescopic steering arm assembly is provided for a vehicle-implement coupling mechanism. The assembly includes a steering arm, a housing, a detent mechanism and a cover. The housing receives an end of the steering arm. The housing has a detent channel which extends inwardly from an opening. The housing forms a rim surrounding the opening, and the housing has an attaching groove formed in the rim. The detent mechanism is movable in the detent channel and engagable with the steering arm for releasably holding the steering arm in the housing. The cover covers the detent mechanism. The cover is mountable to the rim and has a mounting bead which engages the attaching groove.

The housing includes a first housing part and a second housing part. The first and second housing parts being welded together to form a cavity which slidably receives the steering arm. The housing has an open end which receives the steering arm and has a closed end. The detent channel has a longitudinal axis which is perpendicular to a longitudinal axis of the steering arm.

The first second housing parts are joined together along parting surfaces. A portion of the parting surfaces define a first parting plane which extends through the housing from the open end to a side of the detent channel, and this first parting plane is parallel to the longitudinal axis of the detent channel and is parallel to the longitudinal axis of the steering arm.

A further portion of the parting surfaces define a second parting plane which extends through the housing from a second side of the detent channel to an outer side surface of the housing. The second parting plane is parallel to the longitudinal axis of the detent channel and is at an angle with respect to the longitudinal axis of the steering arm. The housing has a rectangular cross-sectional shape with a pair of longer sides on opposite sides of the first parting plane, and with a pair of shorter sides which inter-connect the longer sides with each other.

The first housing part has a connecting region which forms an end or closure wall of the cavity, so that the two housing parts are asymmetrical and the weld seam does not extend through the closure wall. This has the advantage that weld seam in the connecting region of the housing is not exposed to connecting forces. As a result, the housing parts can be manufactured as forging with a very low degree of forming, so that the forging or the housing parts are provided with a relatively flat profile. This makes it possible to apply forging processes with low maintenance cost for the forging tools and the attainment of closer tolerances, so that rework processes can be reduced or even omitted.

The cover includes an edge with a bead which engages the fastening groove in the rim so as to immobilize the detent mechanism at the projection. The cover may be configured in the form of a housing cover, a head or a hood and is preferably formed of sheet metal. The cover has a size and shape so that the cover can be slid over the projection in a positive lock. By beading the edge of the cover in the area of the fastening groove at the projection the cover can be immobilized when the cover is slid over the projection. The beading is preferably formed on the opposite edges of the cover, where corresponding fastening grooves are formed in the rim. This eliminates costly fastening devices such as screws which would require an additional step during the manufacture of the housing.

The detent mechanism includes a spring loaded detent pin that slidably supported in the cover. The detent pin is guided by a rod that extends through the cover and permits the release of the detent pin, and a tension spring is arranged on the rod to pre-load the detent pin in the detent position.

The detent pin slides in guide grooves in the housing sides which extend therein from the opening in the rim. The guide grooves can be forged with the necessary so that a costly milling operation can be omitted.

The opening for the detent mechanism could be provided on any side wall, but is preferably formed, for operator convenience, in the upper side wall of the housing and the guide grooves are formed in the left and right side walls.

Other configurations are also possible. For examples the weld seam could extend along the edges of a lateral side of the housing.

The closed end of housing is welded in a butt joint to a coupling link of the attachment mechanism. The closed end of the housing is preferably large enough to prevent deformation during welding, that could lead to errors in the tolerances of the guides for the detent pin.

### BRIEF DESCRIPTION OF THE DRAWINGS

FIG. 1 is a perspective view of a telescopic steering arm according to the invention.

FIG. 2 is a perspective view from below of a telescopic steering arm according to the invention.

FIG. 3 is a sectional view along lines 3-3 of FIG. 1.

FIG. 4 is a perspective view of the interior of a first housing part.

FIG. 5 is a perspective view of the interior of a second housing part.

FIG. 6 is a sectional view along lines 6-6 of FIG. 1.

FIG. 7 is a perspective view of the telescopic steering arm with a partial sectional view of the detent mechanism of FIG. 6.

### DESCRIPTION OF THE PREFERRED EMBODIMENT

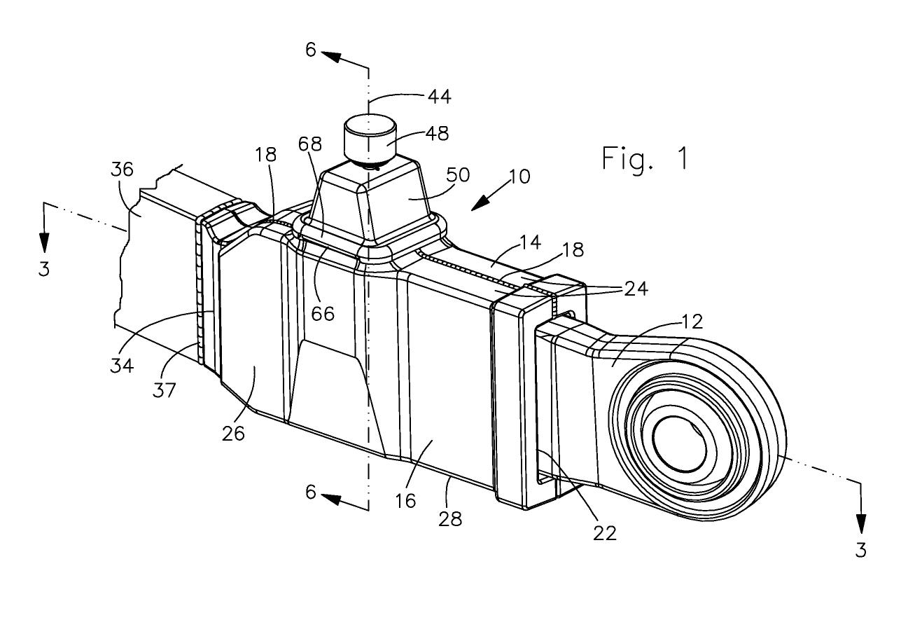

FIGS. 1 through 7 show a housing 10 for a telescopic steering arm 12. Such telescopic steering arms housings 10 are used in attachment mechanisms for agricultural implements (not shown), for example, in a three-point coupling mechanism for an agricultural tractor (not shown).

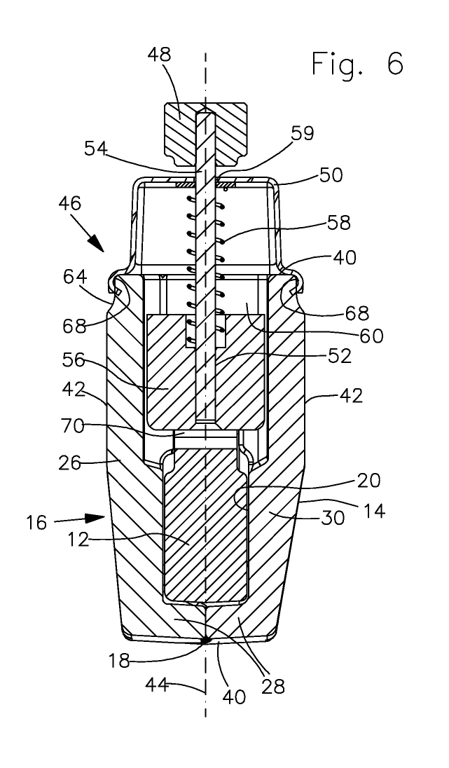

The housing 10 includes a first housing part 14 and a second housing part 16 that are connected to each other along a weld seam 18. The housing 10 encloses a cavity 20 (best seen in FIG. 6) which slidably receives the arm 12.

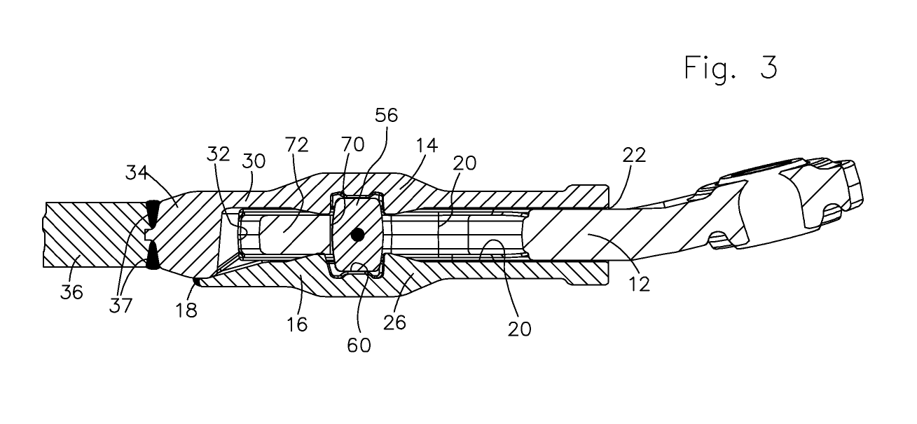

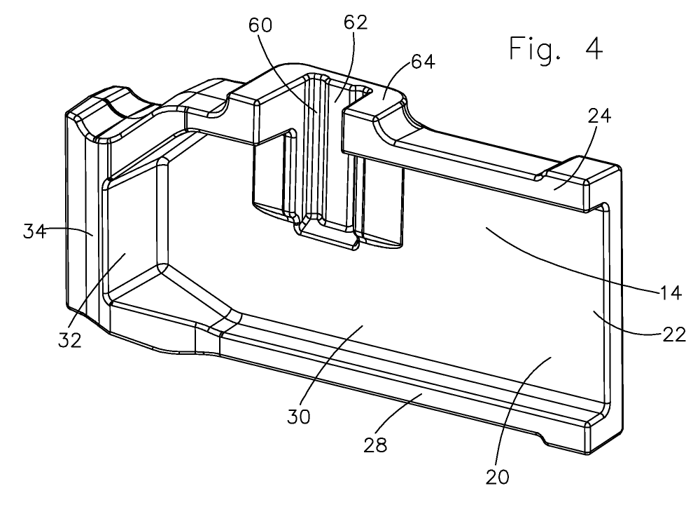

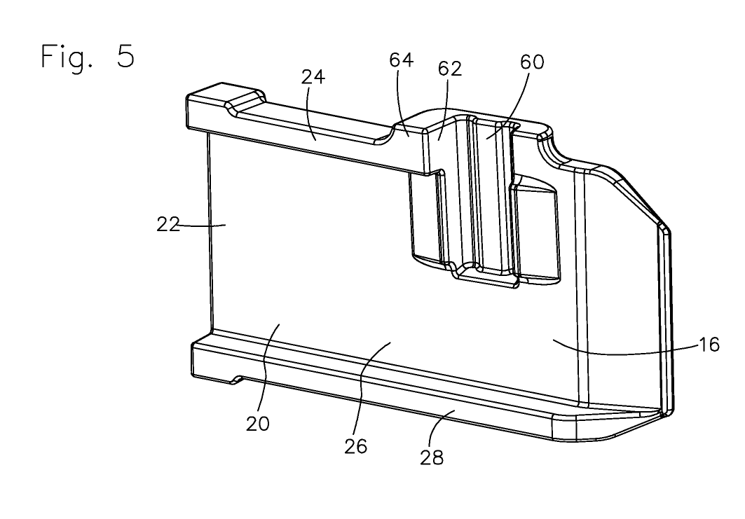

As best seen in FIG. 1, the cavity 20 includes an opening 22 into which the arm 12 is inserted. The cavity 20 is surrounded by a first side wall 24 (see FIG. 4), a second side wall 26 (see FIG. 5), a third side wall 28, a fourth side wall 30 as well as a closure or end wall 32 (see FIGS. 3-5). Walls 24 and 28, and walls 26 and 30, respectively, are arranged opposite each other. Closure wall 22 is arranged opposite opening 22.

The housing parts 14 and 16 are configured as flat profile forgings, where alternative manufacturing techniques are also possible and the housing parts 14, 16 could also be configured, for example, as castings.

As can be seen in FIG. 4, an end part of the first housing part 14 forms part of the opening 22. The first housing part 14 also forms part of walls 24 and 28, and forms the entire wall 30 and the entire closure wall 32. The closure wall 32 is configured as the interior of a massive connecting region 34 formed onto the housing part 14, that is used for the connection to a coupling link 36 of a coupling mechanism (not shown). The connection to the link 36 of the coupling mechanism is established by a welded connection 37.

As can be seen in FIG. 5, an end part of the second housing part 16 forms the other part of opening 22. The second housing part 14 also forms a portion of walls 24 and 28, and forms the entire second side wall 26. The opening 22, wall 24 and wall 28 are completed by the aforementioned parts of the housing parts 14 and 16.

As best seen in FIG. 6, the cavity 20 has a generally rectangular cross section with a long dimension which extends substantially vertically and which lies in a separation or parting plane 44 which lies between portions of the housing parts 14 and 16. The cavity 20 is enclosed by walls 24, 28, 26 and 30. Because of the parting plane, it is possible to configure the housing parts 14, 16 with a generally flat profile, so that these housing parts 14, 16 represent relatively flat forging that can be manufactured in a relatively simpler forging process.

The housing 10 has a rectangular cross-sectional shape with a pair of longer sides on opposite sides of the first parting plane, and with a pair of shorter sides which inter-connect the longer sides with each other.

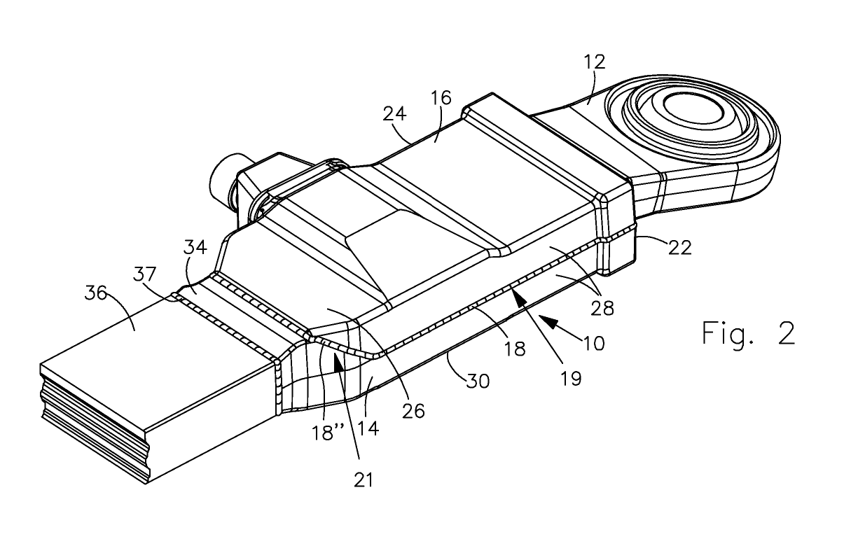

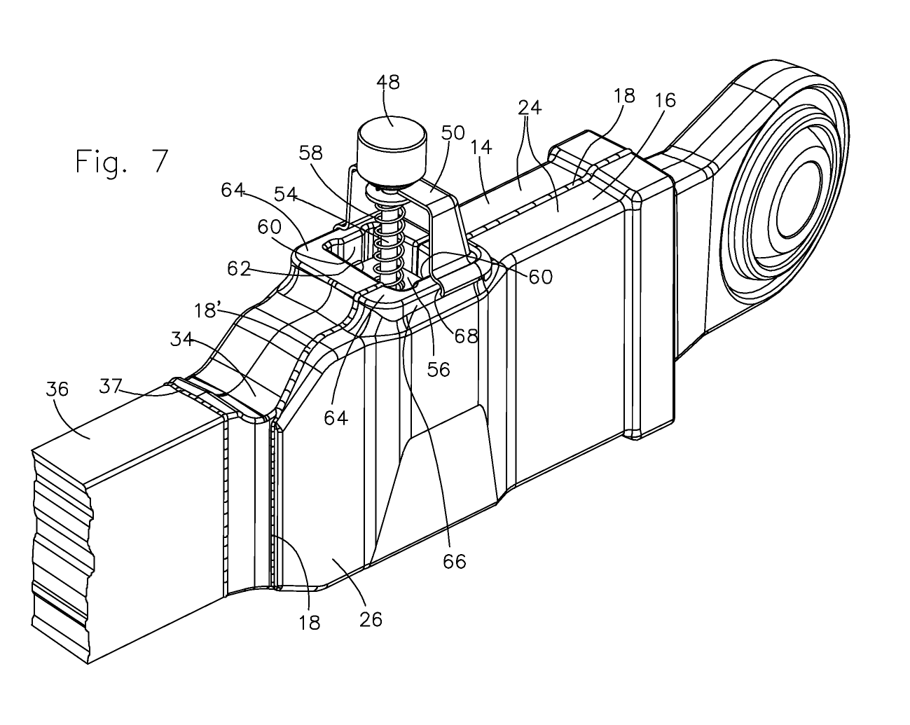

Referring now to FIGS. 2 and 7, the weld seam 18 is arranged along a first parting plane 19 which extends through the middle of walls 24 and 28 from the opening 22 and through the detent channel 60. The weld seam 18 is arranged along a second parting plane 21 which from the opening 22 and through the connecting region 34 to an outer surface of side 26. The first parting plane 19 is parallel to the longitudinal axis of the detent channel 60 and is parallel to the longitudinal axis of the steering arm 12. The second parting plane 21 is parallel to the longitudinal axis of the detent channel 60 and at an angle with respect to the longitudinal axis of the steering arm 12. As best seen in FIG. 7, a portion of the weld seam 18 joins an edge of the connecting region 34 to an edge of wall 26. This prevents dynamic forces in the housing 10 in the connecting region 34 from extending into the weld seam.

As is shown in FIGS. 1 through 3, as well as 6 and 7, the housing 10 includes a detent mechanism 46. The detent mechanism 46 includes a handgrip 48, a cover 50 and a detent pin 52. The detent pin 52 includes a guide rod 54 and a detent block 56. A preload spring 58 is supported on the guide rod 54 between the cover 50 and the detent block 56, and it forces the detent pin 52 into the housing 10 where the guide rod 54 is guided into a bore 59 that is provided in the cover 50 and is connected with the handgrip 48.

The housing parts 14 and 16 have guide grooves 60 formed therein, which together form a detent channel which extends in an upper portion of the housing 10 near closure wall 32. The detent channel extends parallel to and along a vertical axis which lies in the plane 44. The detent channel extends from cavity 20 to an opening 62 in the upper surface of the housing 10. The detent channel conforms to the shape of the detent block 56 so that the detent block 56 is slidable in the detent channel.

The opening 62 is surrounded by a projection or rim 64 on the upper side of the first side wall 24. The rim 64 forms a fastening flange for the cover 50. Attaching grooves 66 are formed on the side of the rim 64 adjacent to side walls 26 and 30 for use in fastening a cover 50.

The cover or hood 50 has a pot-shape and is preferably formed as a deep drawn sheet metal part. The location and length of the cover 50 corresponds approximately to the distance through which the detent block 56 must be slid in the detent channel in order to release the telescopic steering arm 12 and allow it to be retracted from the interior of the housing 10. The opening of the cover 50 is dimensioned so that it encloses the rim 64, and the edge of the opening of the cover 50 includes beads 68 that engage the attaching grooves 66. By pressing the cover 50 over the rim 64, the beads 68 engage the fastening grooves 66 in a detent manner and immobilize the entire detent mechanism 46. The combination of beads 68 and fastening grooves 66 makes it possible to immobilize the detent mechanism 46 without the use of screw threads. The configurations of all the connection necessary for the mechanism and the fastening of the detent mechanism 46 on the housing parts 14, 16 such as, for example, the guide grooves 60, the fastening grooves 66, the opening 62 and the rim 64 can be incorporated into the forging process, so that costly subsequent rework processes such as, for example, milling, can be omitted.

Spring 58 urges detent block 56 into a notch or depression 70 which is formed in the steering arm 12. The inner end 72 of the steering arm 12 includes a slanted surface which engages and raises the detent pin 52 as the steering arm 12 is inserted into housing 10. When depression 70 is aligned with groove 60 then spring 58 moves detent block 56 into depression 70 and the steering arm 12 is immobilized with respect to the housing 10. By pulling the handgrip 48 or by applying a force opposed to the spring 58, the detent block 56 can be moved out of the depression 70 so as to release the detent and allow steering arm 12 to be withdrawn or moved out of the housing 10.

While the present invention has been described in conjunction with a specific embodiment, it is understood that many alternatives, modifications and variations will be apparent to those skilled in the art in light of the foregoing description. Accordingly, this invention is intended to embrace all such alternatives, modifications and variations which fall within the spirit and scope of the appended claims.

We claim:

1. A telescopic steering arm assembly for a vehicle-implement coupling mechanism, the assembly comprising:
a steering arm;
a housing for receiving an end of the steering arm, the housing having a detent channel 60 extending therein from an opening, the housing forming a rim surrounding the opening, and the housing having an attaching groove formed in the rim;
a detent mechanism movable in the detent channel and engagable with the steering arm for releasably holding the steering arm in the housing; and
a cover for covering the detent mechanism, the cover being mountable to the rim and having a mounting bead which engages the attaching groove.

2. The steering arm assembly of claim 1, wherein:
the housing comprises a first housing part and a second housing part, the first and second housing parts being welded together to form a cavity which slidably receives the steering arm, the housing having an open end which receives the steering arm and having a closed end, the detent channel having a longitudinal axis which is perpendicular to a longitudinal axis of the steering arm, the first second housing parts being joined together along parting surfaces, a portion of the parting surfaces defining a first parting plane which extends through the housing from the open end to a side of the detent channel, and the first parting plane being parallel to the longitudinal axis of the detent channel and being parallel to the longitudinal axis of the steering arm.

3. The steering arm assembly of claim 2, wherein:
a further portion of the parting surfaces defining a second parting plane which extends through the housing from a second side of the detent channel to an outer side surface of the housing, and the second parting plane being parallel to the longitudinal axis of the detent channel and being at an angle with respect to the longitudinal axis of the steering arm.

4. The steering arm assembly of claim 1, wherein:
the detent mechanism includes a spring preloaded detent pin which is slidably supported by in the cover.

5. The steering arm assembly of claim 2, wherein:
the first housing part includes a first side wall, and the second housing part includes a second side wall; and
the detent mechanism includes a spring preloaded detent pin which is slidably supported by in the cover, the detent pin slidably engaging first and second side walls.

6. The steering arm assembly of claim 5, wherein:
the detent channel is formed by guide grooves formed in the first and second side walls.

7. The steering arm assembly of claim 2, wherein:
the closed end of the housing is welded to a coupling link.

8. The steering arm assembly of claim 2, wherein:
the housing has a rectangular cross-sectional shape with a pair of longer sides on opposite sides of the first parting plane, and with a pair of shorter sides which inter-connect the longer sides with each other.
